(19) United States
(12) Patent Application Publication
(10) Pub. No.: US 2013/0229430 A1
(43) Pub. Date: Sep. 5, 2013

(54) METHOD AND DEVICE FOR SIMULATION OF IMAGE AT OBLIQUE VIEW ANGLE

(71) Applicants: Li xuan Chen, Shenzhen (CN); Chih-tsung Kang, Shenzhen (CN)

(72) Inventors: Li xuan Chen, Shenzhen (CN); Chih-tsung Kang, Shenzhen (CN)

(73) Assignee: SHENZHEN CHINA STAR OPTOELECTRONICS TECHNOLOGY CO. LTD., Shenzhen (CN)

(21) Appl. No.: 13/510,003

(22) PCT Filed: Mar. 6, 2012
(86) PCT No.: PCT/CN12/71957

§ 371 Date: May 16, 2012

(30) Foreign Application Priority Data
Mar. 1, 2012 (CN) 201210051317.9

(51) Int. Cl. G09G 5/02

(52) U.S. Cl. CPC G09G 5/02
USPC 345/600

(57) ABSTRACT

The present invention discloses a method and a device for simulation of image at oblique view angle. The method includes: obtaining stimulus values of multiple front-view grey scales in a front viewing condition and stimulus values of multiple oblique-view grey scales in an oblique viewing condition for at least one elementary color of a display device; determining a pairing relationship between the front-view grey scales and the oblique-view grey scales according to the stimulus values of the front-view grey scales and the stimulus values of the oblique-view grey scales; obtaining a front-view image; and converting the front-view image into an oblique-view image according to the pairing relationship. The present invention can directly obtain an image of oblique view angle in a real-time manner without making any measurement. The process is simple and may provide high accuracy of oblique view image simulation and eliminate color shifting in simulating oblique view image.

### BACKGROUND OF THE INVENTION

1. Field of the Invention

The present invention relates to the field of display devices, and in particular to a method and device for simulation of image at oblique view angle.

2. The Related Arts

White balance is an extremely important concept in the field of display devices for it helps handle a series of problems associated with color reproduction and tone processing.

In adjustment of liquid crystal display device, to have the displayed white color satisfy the desired chromaticity and showing no color shift, white balance operations are commonly used for adjustment. The white balance of liquid crystal display device is related to both the adjustment of front view angle and the displaying of image at an oblique view angle.

The conventional way of white balance adjustment for the liquid crystal display devices is carried out by first burning white balance algorithm for front view angle in a display control chip and then observing if the displaying of an oblique view angle deviates. The process is repeatedly carried out and the burning and adjusting process is tedious, making real time adjustability very poor and causing color shifting at the oblique view angle.

Thus, it is desired to have a method and device for simulation of image at oblique view angle, which realize real time simulation of image at oblique view angle.

### SUMMARY OF THE INVENTION

The technical issue to be addressed by the present invention is to provide a method and device for simulation of image at oblique view angle, which realize real time simulation image of oblique view angle.

To address the above technical issue, the present invention adopts a technical solution, which provides a method for simulation of image at oblique view angle. The method for simulation of image at oblique view angle comprises the following steps: obtaining stimulus values of multiple front-view grey scales in a front viewing condition and stimulus values of multiple oblique-view grey scales in an oblique viewing condition for at least one elementary color of a display device; determining a pairing relationship between the front-view grey scales and the oblique-view grey scales according to the stimulus values of the front-view grey scales and the stimulus values of the oblique-view grey scales; obtaining a front-view image; and converting the front-view image into an oblique-view image according to the pairing relationship.

According to a preferred embodiment of the present invention, the step of obtaining stimulus values of multiple front-view grey scales in a front viewing condition and stimulus values of multiple oblique-view grey scales in an oblique viewing condition for at least one elementary color of a display device comprises: obtaining a gamma curve of front view and a gamma curve of oblique view for at least one elementary color; and determining the stimulus values of multiple front-view grey scales according to the front-view gamma curve, and determining the stimulus values of multiple oblique-view grey scales according to the oblique-view gamma curve.

According to a preferred embodiment of the present invention, the at least one elementary color comprises red, green, and blue.

According to a preferred embodiment of the present invention, the front-view grey scales are grey scales obtained at a front view angle of the display device and the oblique-view grey scales are grey scales obtained at an angle of 30 degrees relative to the front view angle of the display device.

According to a preferred embodiment of the present invention, the front-view grey scales and the oblique-view grey scales both comprise 256 grey scales.

According to a preferred embodiment of the present invention, the step of determining a pairing relationship between the front-view grey scales and the oblique-view grey scales according to the stimulus values of the front-view grey scales and the stimulus values of the oblique-view grey scales comprises: calculating difference between the stimulus value of each oblique-view grey scale and the stimulus value of each front-view grey scale; and establishing correlation of pairing relationship between each oblique-view grey scale and the one of the front-view grey scales that has a difference that is closest to zero.

According to a preferred embodiment of the present invention, the step of obtaining a front-view image comprises: obtaining an original image; and performing white balance processing on the original image to obtain a front-view image.

According to a preferred embodiment of the present invention, the method for simulation of image at oblique view angle further comprises: adjusting a parameter of the white balance processing according to the oblique-view image.

To address the above technical issue, the present invention adopts another technical solution, which provides a device for simulation of image at oblique view angle. The device for simulation of image at oblique view angle comprises: a grey scale stimulus value acquiring unit, which obtains stimulus values of multiple front-view grey scales in a front viewing condition and stimulus values of multiple oblique-view grey scales in an oblique viewing condition for at least one elementary color of a display device; a pairing relationship acquiring unit, which determines a pairing relationship between the front-view grey scales and the oblique-view grey scales according to the stimulus values of the front-view grey scales and the stimulus values of the oblique-view grey scales; a front-view image acquiring unit, which obtains a front-view image; and an oblique-view image acquiring unit, converts the front-view image into an oblique-view image according to the pairing relationship.

According to a preferred embodiment of the present invention, the grey scale stimulus value acquiring unit is operative to: obtain a gamma curve of front view and a gamma curve of oblique view for at least one elementary color; and determine the stimulus values of multiple front-view grey scales according to the front-view gamma curve and determine the stimulus values of multiple oblique-view grey scales according to the oblique-view gamma curve.

According to a preferred embodiment of the present invention, the at least one elementary color comprises red, green, and blue.

According to a preferred embodiment of the present invention, the front-view grey scales are grey scales obtained at a front view angle of the display device and the oblique-view grey scales are grey scales obtained at an angle of 30 degrees relative to the front view angle of the display device.

According to a preferred embodiment of the present invention, the front-view grey scales and the oblique-view grey scales both comprise 256 grey scales.

According to a preferred embodiment of the present invention, the pairing relationship acquiring unit is operative to: calculate difference between the stimulus value of each oblique-view grey scale and the stimulus value of each front-view grey scale; and establish correlation of pairing relationship between each oblique-view grey scale and the one of the front-view grey scales that has a difference that is closest to zero.

According to a preferred embodiment of the present invention, the front-view image acquiring unit is operative to: obtain an original image; and perform white balance processing on the original image to obtain a front-view image.

According to a preferred embodiment of the present invention, the oblique-view image acquiring unit is further operative to: adjust a parameter of the white balance processing according to the oblique-view image.

To address the above technical issue, the present invention adopts a further technical solution, which provides a method for simulation of image at oblique view angle. The method for simulation of image at oblique view angle comprises the following steps: obtaining stimulus values of multiple front-view grey scales in a front viewing condition and stimulus values of multiple oblique-view grey scales in an oblique viewing condition for at least one elementary color of a display device; calculating difference between the stimulus value of each oblique-view grey scale and the stimulus value of each front-view grey scale; establishing correlation of pairing relationship between each oblique-view grey scale and the one of the front-view grey scales that has a difference that is closest to zero; obtaining an original image; performing white balance processing on the original image to obtain a front-view image; and converting the front-view image into an oblique-view image according to the pairing relationship.

According to a preferred embodiment of the present invention, the step of obtaining stimulus values of multiple front-view grey scales in a front viewing condition and stimulus values of multiple oblique-view grey scales in an oblique viewing condition for at least one elementary color of a display device comprises: obtaining a gamma curve of front view and a gamma curve of oblique view for at least one elementary color; and determining the stimulus values of multiple front-view grey scales according to the front-view gamma curve, and determining the stimulus values of multiple oblique-view grey scales according to the oblique-view gamma curve.

According to a preferred embodiment of the present invention, the at least one elementary color comprises red, green, and blue.

According to a preferred embodiment of the present invention, the front-view grey scales are grey scales obtained at a front view angle of the display device and the oblique-view grey scales are grey scales obtained at an angle of 30 degrees relative to the front view angle of the display device.

The efficacy of the present invention is that to be distinguished from the state of the art, the method and device for simulation of image at oblique view angle according to the present invention does not need to make measurement and can directly obtain oblique view image in a real-time manner. The process is simple and provides high accuracy of simulating oblique view image and can effectively eliminate color shifting in the simulation of oblique view image.

### BRIEF DESCRIPTION OF THE DRAWINGS

To more clearly expound the technical solution adopted in the embodiments of the present invention, a brief description will be given to the drawings that necessary for the illustration of the embodiments. Apparently, the drawings described below show only example embodiments of the present invention and for those having ordinary skills in the art, other drawings may be easily obtained from these drawings without paying any creative effort. In the drawings:

FIG. 1 is a flow chart of a method for simulation of image at oblique view angle according to an embodiment of the present invention;

FIG. 2 is a schematic view showing a device for simulation of image at oblique view angle according an embodiment of the present invention;

FIG. 3 is a flow chart illustrating a practical operation of the method for simulation of image at oblique view angle according to the present invention; and

FIG. 4 is a plot showing curves of grey scales of the G elementary color at front view angle and oblique view angle and the associated stimulus values G(Y).

### DETAILED DESCRIPTION OF THE PREFERRED EMBODIMENTS

A detailed description of the present invention will be given with reference to the attached drawings and embodiments.

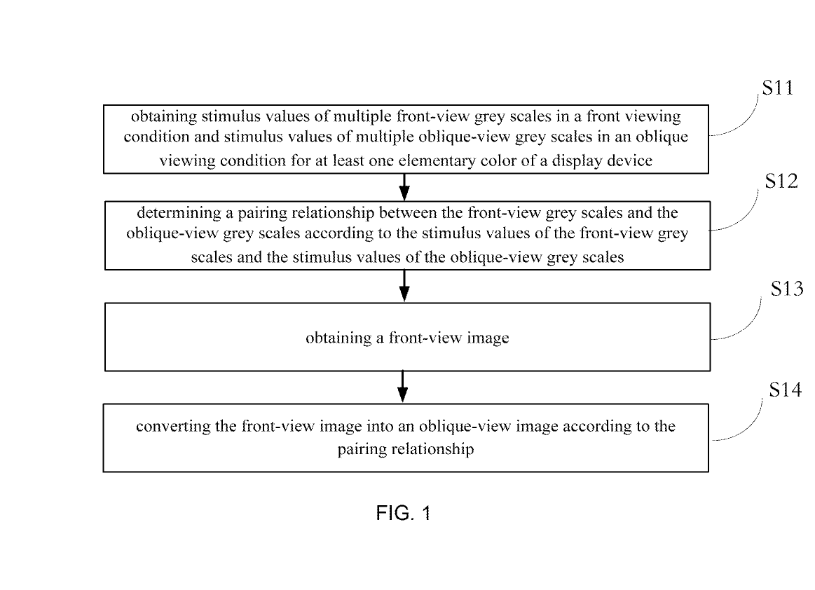

FIG. 1 is a flow chart of a method for simulation of image at oblique view angle according to an embodiment of the present invention. As shown in FIG. 1, the method for simulation of image at oblique view angle according to an embodiment of the present invention comprises the following steps:

Step S11: obtaining stimulus values of multiple front-view grey scales in a front viewing condition and stimulus values of multiple oblique-view grey scales in an oblique viewing condition for at least one elementary color of a display device;

Step S12: determining a pairing relationship between the front-view grey scales and the oblique-view grey scales according to the stimulus values of the front-view grey scales and the stimulus values of the oblique-view grey scales;

Step S13: obtaining a front-view image; and

Step S14: converting the front-view image into an oblique-view image according to the pairing relationship.

If the display device uses RGB based three elementary colors, then said at least one elementary color may be red, green, or blue; if the display device uses RGBCMY based six elementary colors, then said at least one elementary color is red, green, blue, cyan, magenta, or yellow. It is apparent that the display device may employ other chromatic principles that are known and of which detailed descriptions are omitted herein.

The front-view grey scales are the grey scales of the display device in the direction of front view angle, while the oblique-view grey scales are grey scales of the display device at an angle that is oblique with respect to the front view direction. For example, the oblique-view grey scales are grey scales at an angle of 30 degrees or those at an angle of 35 degrees with respect to the front view angle of the display device. The specific angles of different embodiments can be modified according the practical needs and further description will be omitted herein.

The grey scales are the scales of brightness of each elementary color from the darkest condition to the brightest condition. The number of grey scales of the front-view grey scales and the oblique-view grey scales are dependent upon the number of grey scales of the elementary color of a display device. For example, when a display device is an 8-bit display device, the front-view grey scales and the oblique-view grey scales both include 256 grey scales; when a display device is a 10-bit display device, the front-view grey scales and the oblique-view grey scales both include 1024 grey scales. Further example will be omitted.

Tristimulus values are the quantified values indicating the intensities of stimulus of the three primary colors, namely red, green, and blue, that human retina perceives for a given color and will be respectively represented by R(X), G(Y), and B(Z).

In the instant embodiment, Step S11 comprises:

obtaining a gamma curve of front view and a gamma curve of oblique view for at least one elementary color; and

determining the stimulus values of multiple front-view grey scales according to the front-view gamma curve, and determining the stimulus values of multiple oblique-view grey scales according to the oblique-view gamma curve.

The gamma curves can be obtained with known techniques and no description will be given herein.

In the instant embodiment, Step S12 comprises:

calculating difference between the stimulus value of each oblique-view grey scale and the stimulus value of each front-view grey scale; and

establishing correlation of pairing relationship between each oblique-view grey scale and the one of the front-view grey scales that has a difference that is closest to zero (0).

Taking a display device adopting three elementary colors of RGB, in Step S12, for the stimulus value of each front-view grey scale of each elementary color RGB in the front view, there is always one stimulus value of the oblique-view grey scales that is closest to the front-view grey scale stimulus value, and thus, the front-view grey scale and the oblique-view grey scale that are respectively associated with the two stimulus values establish a pairing relationship therebetween.

In the instant embodiment, Step S13 comprises:

obtaining an original image; and

performing white balance processing on the original image to obtain a front-view image.

With the above process, an oblique-view simulation image can be obtained in a real-time manner in the white balance adjustment process of the liquid crystal display device and the process is simple.

In the instant embodiment, after Step S14, the method for simulation of oblique-view image may further comprise the following step: adjusting a parameter of the white balance processing according to the oblique-view image.

The operation of adjusting the white balance processing parameter can be done with techniques that are conventionally known and no further description will be given herein.

With the above method, the efficiency and the result of white balance adjustment of liquid crystal display devices can both be improved.

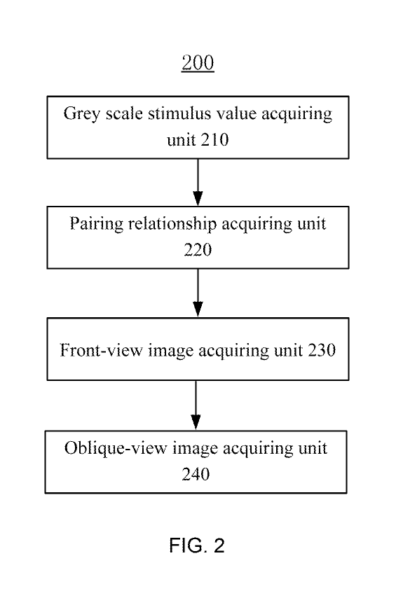

FIG. 2 is a schematic view showing a device for simulation of image at oblique view angle according to an embodiment of the present invention. As shown in FIG. 2, the device for simulation of image at oblique view angle according to the embodiment of the present invention, which is generally designated at 200, comprises a grey scale stimulus value acquiring unit 210, a pairing relationship acquiring unit 220, a front-view image acquiring unit 230, and an oblique-view image acquiring unit 240.

In the instant embodiment, reference is made to the details of the previously described method for simulation of image at oblique view angle according to the previous embodiment of the present invention in respect of the limitations imposed to at least one elementary color, front-view grey scales, oblique-view grey scales, number of scales of the front-view grey scales and the oblique-view grey scales, gamma curves, pairing relationship between front-view grey scales and oblique-view grey scales, adjusting of parameter for white balance processing, and tristimulus values. Repeated description will be omitted.

The grey scale stimulus value acquiring unit 210 obtains stimulus values of multiple front-view grey scales in a front viewing condition and stimulus values of multiple oblique-view grey scales in an oblique viewing condition for at least one elementary color of a display device.

In the instant embodiment, the grey scale stimulus value acquiring unit 210 obtains first a gamma curve of front view and a gamma curve of oblique view for at least one elementary color and then determines the stimulus values of multiple front-view grey scales according to the front-view gamma curve and determines the stimulus values of multiple oblique-view grey scales according to the oblique-view gamma curve.

The pairing relationship acquiring unit 220 determines a pairing relationship between the front-view grey scales and the oblique-view grey scales according to the stimulus values of the front-view grey scales and the stimulus values of the oblique-view grey scales.

In the instant embodiment, the pairing relationship acquiring unit 220 first calculates difference between the stimulus value of each oblique-view grey scale and the stimulus value of each front-view grey scale and then establishes correlation of pairing relationship between each oblique-view grey scale and the one of the front-view grey scales that has a difference that is closest to zero (0).

The front-view image acquiring unit 230 obtains a front-view image.

In the instant embodiment, the front-view image acquiring unit 230 first obtains an original image and then performs white balance processing on the original image to obtain a front-view image.

The oblique-view image acquiring unit 240 converts the front-view image into an oblique-view image according to the pairing relationship. In the instant embodiment, the oblique-view image acquiring unit 240 may further function to adjust a parameter of the white balance processing according to the oblique-view image.

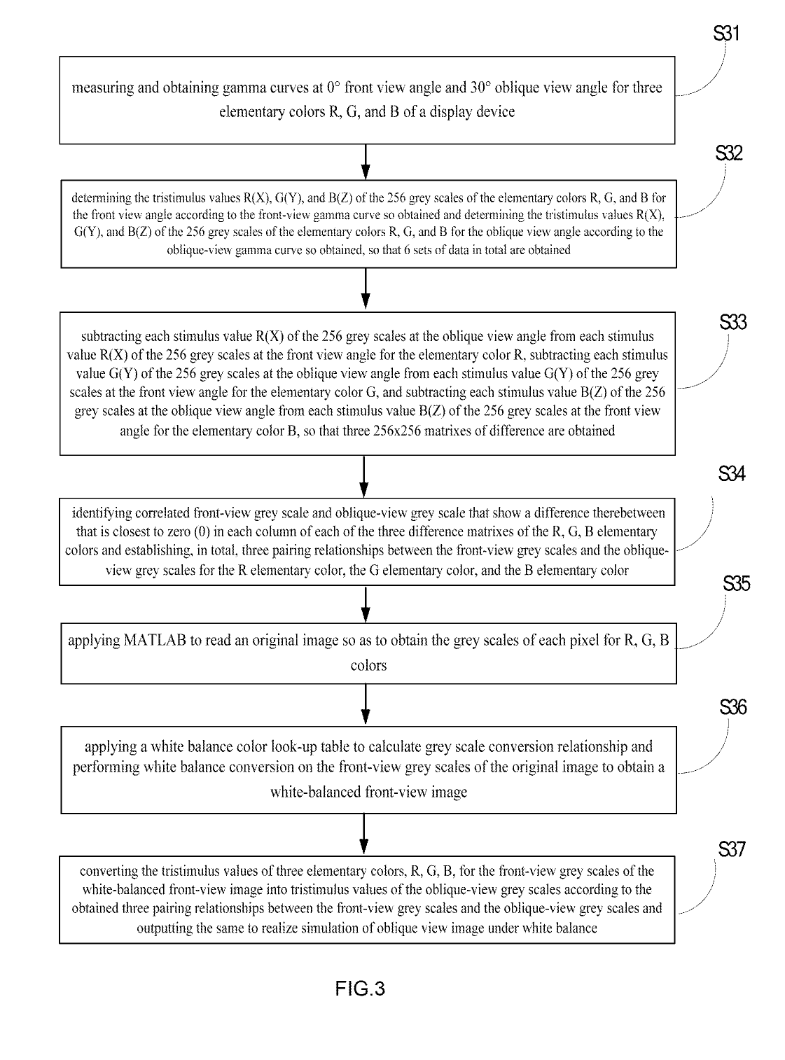

FIG. 3 is a flow chart illustrating a practical operation of the method for simulation of image at oblique view angle according to the present invention. In this illustrative operation, the liquid crystal display device adopts three elementary colors of RGB, each of which has 256 grey scales. As shown in FIG. 3, the method for simulation of image at oblique view angle comprises the following steps:

Step S31: measuring and obtaining gamma curves at 0° front view angle and 30° oblique view angle for three elementary colors R, G, and B of a display device.

Step S32: determining the tristimulus values R(X), G(Y), and B(Z) of the 256 grey scales of the elementary colors R, G, and B for the front view angle according to the front-view gamma curve so obtained and determining the tristimulus values R(X), G(Y), and B(Z) of the 256 grey scales of the elementary colors R, G, and B for the oblique view angle according to the oblique-view gamma curve so obtained, so that 6 sets of data in total are obtained.

Step S33: subtracting each stimulus value R(X) of the 256 grey scales at the oblique view angle from each stimulus value R(X) of the 256 grey scales at the front view angle for the elementary color R, subtracting each stimulus value G(Y) of the 256 grey scales at the oblique view angle from each stimulus value G(Y) of the 256 grey scales at the front view angle for the elementary color G, and subtracting each stimulus value B(Z) of the 256 grey scales at the oblique view angle from each stimulus value B(Z) of the 256 grey scales at the front view angle for the elementary color B, so that three 256×256 matrixes of difference are obtained.

Step S34: identifying correlated front-view grey scale and oblique-view grey scale that show a difference therebetween that is closest to zero (0) in each column of each of the three difference matrixes of the R, G, B elementary colors and establishing, in total, three pairing relationships between the front-view grey scales and the oblique-view grey scales for the R elementary color, the G elementary color, and the B elementary color.

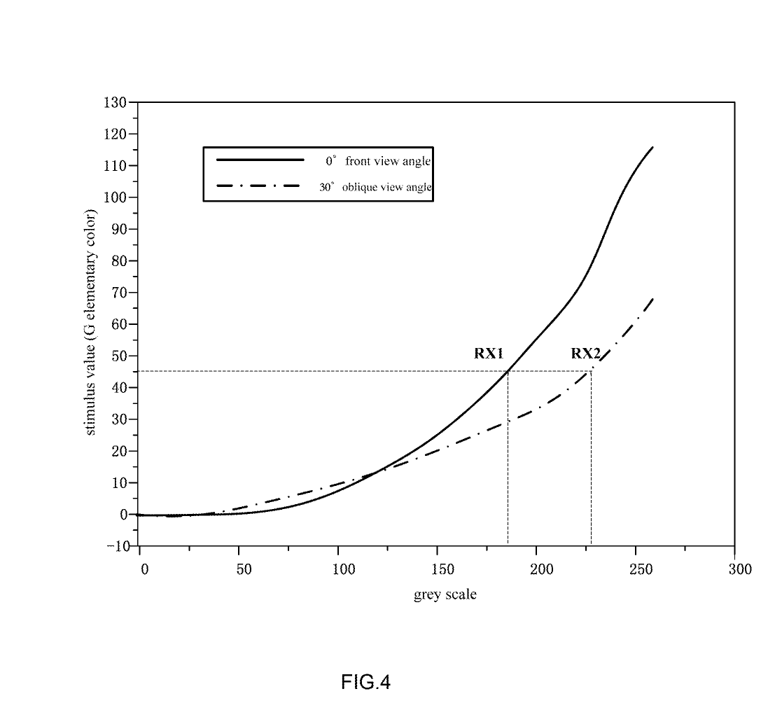

FIG. 4 is a plot showing curves of grey scales of the G elementary color at the front view angle and the oblique view angle and the associated stimulus values G(Y). As shown in FIG. 4, the G color has a front view grey scale having a stimulus value of RX1 and an oblique view grey scale having a stimulus value RX2 between which the difference is the one that is closest to zero (0) in the column. Thus, RX1 and RX2 establish a grey scale correlating relationship between the front view angle and the oblique view angle for the G elementary color. For the stimulus value of each grey scale of each of the three elementary colors, R, G, B, at the front view angle, there is always a stimulus value of the grey scales at the oblique view angle. Based on the grey scales corresponding to these grey scale stimulus values, three pairing relationships between the front-view grey scales and the oblique-view grey scales can be established respectively for the R elementary color, the G elementary color, and the B elementary color.

Step S35: applying MATLAB to read an original image so as to obtain the grey scales of each pixel for R, G, B colors.

MATLAB is mathematic software that is conventionally known and further details will not be given herein.

Step S36: applying a white balance color look-up table to calculate grey scale conversion relationship and performing white balance conversion on the front-view grey scales of the original image to obtain a white-balanced front-view image.

The color look-up table is a table built in a video card of a computer and color signal values are established in the table to respectively correspond to all the different colors that a display device of the computer is capable of displaying. The techniques of color look-up table are known and further details will be omitted herein.

Step S37: converting the tristimulus values of three elementary colors, R, G, B, for the front-view grey scales of the white-balanced front-view image into tristimulus values of the oblique-view grey scales according to the obtained three pairing relationships between the front-view grey scales and the oblique-view grey scales and outputting the same to realize simulation of oblique view image under white balance.

The method and device for simulation of image at oblique view angle according to the present invention does not need to make measurement and can directly obtain oblique view image in a real-time manner. The process is simple and provides high accuracy of simulating oblique view image and can effectively eliminate color shifting in the simulation of oblique view image.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the dams of the present invention.

What is claimed is:

1. A method for simulation of image at oblique view angle, characterized in that the method comprises the following steps:
obtaining stimulus values of multiple front-view grey scales in a front viewing condition and stimulus values of multiple oblique-view grey scales in an oblique viewing condition for at least one elementary color of a display device;
determining a pairing relationship between the front-view grey scales and the oblique-view grey scales according to the stimulus values of the front-view grey scales and the stimulus values of the oblique-view grey scales;
obtaining a front-view image; and
converting the front-view image into an oblique-view image according to the pairing relationship.

2. The method for simulation of image at oblique view angle as claimed in claim 1, characterized in that the step of obtaining stimulus values of multiple front-view grey scales in a front viewing condition and stimulus values of multiple oblique-view grey scales in an oblique viewing condition for at least one elementary color of a display device comprises:
obtaining a gamma curve of front view and a gamma curve of oblique view for at least one elementary color; and
determining the stimulus values of multiple front-view grey scales according to the front-view gamma curve, and determining the stimulus values of multiple oblique-view grey scales according to the oblique-view gamma curve.

3. The method for simulation of image at oblique view angle as claimed in claim 1, characterized in that the at least one elementary color comprises red, green, and blue.

4. The method for simulation of image at oblique view angle as claimed in claim 1, characterized in that the front-view grey scales are grey scales obtained at a front view angle of the display device and the oblique-view grey scales are grey scales obtained at an angle of 30 degrees relative to the front view angle of the display device.

5. The method for simulation of image at oblique view angle as claimed in claim 1, characterized in that the front-view grey scales and the oblique-view grey scales both comprise 256 grey scales.

6. The method for simulation of image at oblique view angle as claimed in claim 1, characterized in that the step of determining a pairing relationship between the front-view grey scales and the oblique-view grey scales according to the stimulus values of the front-view grey scales and the stimulus values of the oblique-view grey scales comprises:
calculating difference between the stimulus value of each oblique-view grey scale and the stimulus value of each front-view grey scale; and
establishing correlation of pairing relationship between each oblique-view grey scale and the one of the front-view grey scales that has a difference that is closest to zero.

7. The method for simulation of image at oblique view angle as claimed in claim 1, characterized in that the step of obtaining a front-view image comprises:
obtaining an original image; and
performing white balance processing on the original image to obtain a front-view image.

8. The method for simulation of image at oblique view angle as claimed in claim 7, characterized in that the method further comprises:
adjusting a parameter of the white balance processing according to the oblique-view image.

9. A device for simulation of image at oblique view angle, characterized in that the device comprises:
a grey scale stimulus value acquiring unit, which obtains stimulus values of multiple front-view grey scales in a front viewing condition and stimulus values of multiple oblique-view grey scales in an oblique viewing condition for at least one elementary color of a display device;
a pairing relationship acquiring unit, which determines a pairing relationship between the front-view grey scales and the oblique-view grey scales according to the stimulus values of the front-view grey scales and the stimulus values of the oblique-view grey scales;
a front-view image acquiring unit, which obtains a front-view image; and
an oblique-view image acquiring unit, converts the front-view image into an oblique-view image according to the pairing relationship.

10. The device for simulation of image at oblique view angle as claimed in claim 9, characterized in that the grey scale stimulus value acquiring unit is operative to:
obtain a gamma curve of front view and a gamma curve of oblique view for at least one elementary color; and
determine the stimulus values of multiple front-view grey scales according to the front-view gamma curve and determine the stimulus values of multiple oblique-view grey scales according to the oblique-view gamma curve.

11. The device for simulation of image at oblique view angle as claimed in claim 9, characterized in that the at least one elementary color comprises red, green, and blue.

12. The device for simulation of image at oblique view angle as claimed in claim 9, characterized in that the front-view grey scales are grey scales obtained at a front view angle of the display device and the oblique-view grey scales are grey scales obtained at an angle of 30 degrees relative to the front view angle of the display device.

13. The device for simulation of image at oblique view angle as claimed in claim 9, characterized in that the front-view grey scales and the oblique-view grey scales both comprise 256 grey scales.

14. The device for simulation of image at oblique view angle as claimed in claim 9, characterized in that the pairing relationship acquiring unit is operative to:
calculate difference between the stimulus value of each oblique-view grey scale and the stimulus value of each front-view grey scale; and
establish correlation of pairing relationship between each oblique-view grey scale and the one of the front-view grey scales that has a difference that is closest to zero.

15. The device for simulation of image at oblique view angle as claimed in claim 9, characterized in that the front-view image acquiring unit is operative to:
obtain an original image; and
perform white balance processing on the original image to obtain a front-view image.

16. The device for simulation of image at oblique view angle as claimed in claim 15, characterized in that the oblique-view image acquiring unit is further operative to:
adjust a parameter of the white balance processing according to the oblique-view image.

17. A method for simulation of image at oblique view angle, characterized in that the method comprises the following steps:
obtaining stimulus values of multiple front-view grey scales in a front viewing condition and stimulus values of multiple oblique-view grey scales in an oblique viewing condition for at least one elementary color of a display device;
calculating difference between the stimulus value of each oblique-view grey scale and the stimulus value of each front-view grey scale;
establishing correlation of pairing relationship between each oblique-view grey scale and the one of the front-view grey scales that has a difference that is closest to zero;
obtaining an original image;
performing white balance processing on the original image to obtain a front-view image; and
converting the front-view image into an oblique-view image according to the pairing relationship.

18. The method for simulation of image at oblique view angle as claimed in claim 17, characterized in that the step of obtaining stimulus values of multiple front-view grey scales in a front viewing condition and stimulus values of multiple oblique-view grey scales in an oblique viewing condition for at least one elementary color of a display device comprises:
obtaining a gamma curve of front view and a gamma curve of oblique view for at least one elementary color; and
determining the stimulus values of multiple front-view grey scales according to the front-view gamma curve, and determining the stimulus values of multiple oblique-view grey scales according to the oblique-view gamma curve.

19. The method for simulation of image at oblique view angle as claimed in claim 17, characterized in that the at least one elementary color comprises red, green, and blue.

20. The method for simulation of image at oblique view angle as claimed in claim 17, characterized in that the front-view grey scales are grey scales obtained at a front view angle of the display device and the oblique-view grey scales are grey scales obtained at an angle of 30 degrees relative to the front view angle of the display device.
